(19) United States
(12) Patent Application Publication
(10) Pub. No.: US 2009/0193622 A1
(43) Pub. Date: Aug. 6, 2009

(54) HINGE FOR DOORS OR WINDOWS

(75) Inventor: Aimone BALBO DI VINADIO, Chiusa San Michele (Torino) (IT)

Correspondence Address: NIXON & VANDERHYE, PC, 901 NORTH GLEBE ROAD, 11TH FLOOR, ARLINGTON, VA, 22203, US

(73) Assignee: SAVIO S.p.A., Chiusa San Michele (Torino) (IT)

(21) Appl. No.: 12/361,822

(22) Filed: Jan. 29, 2009

(30) Foreign Application Priority Data
Jan. 31, 2008 (EP) 08425056.2

(51) Int. Cl. E05D 5/12

(52) U.S. Cl. 16/381; 16/380

(57) ABSTRACT

A hinge for doors or windows, comprising a hinge-pin (26) defining an axis of articulation (28), a first hinge element and a second hinge element (22, 24) articulated to one another about said axis (28) via said pin (26), in which the first hinge element and the second hinge element (22, 24) have respective articulation seats (44, 62) for coupling with said pin (26) and respective front surfaces facing one another (42, 58), in which a washer (30) is set between said front facing surfaces (44, 58), and in which said pin (26) has an annular groove (68) on its external surface for engagement by a fixing screw (72) carried by the second hinge element. The washer (30) comprises at least one extension (82, 84), which extends within the articulation seat (44) of the first hinge element (22) parallel to said axis of articulation (28), said extension (82, 84) having at least one tooth (88) configured for engaging elastically said annular groove (68) of the pin (26) so as to withhold the pin (26) provisionally within said articulation seat (44) in the direction of the axis of articulation (28).

### BACKGROUND OF THE INVENTION

The present invention relates to a hinge for doors or windows, in particular for doors or windows with aluminum frames. More precisely, the invention relates to a hinge comprising a first hinge element and a second hinge element articulated to one another by means of a hinge-pin and comprising moreover a washer set between the mutually facing front surfaces of the first and second hinge elements.

During setting in place, the first hinge element is fixed to the fixed frame of the door or window, the second hinge element is fixed to the mobile frame, and then the two hinge elements are connected together in an articulated way by means of the pin after alignment of the articulation seats with one another, attention being paid to set the washer between the facing surfaces of the two hinge elements and with the hole of the washer aligned to the articulation seats. These operations normally require the intervention of two people, since just one operator would not be able to set the hinge elements of the mobile leaf in alignment with the hinge elements of the fixed frame, to position the washers and simultaneously insert the hinge-pins.

The object of the present invention is to provide an improved hinge that will enable simplification of the operations of assembly and that will enable setting in place of a door or window even by just one operator.

### SUMMARY OF THE INVENTION

According to the present invention, the above object is achieved by a hinge wherein said washer comprises at least one extension, which extends within the articulation seat of the first hinge element parallel to said axis of articulation, said extension having at least one tooth configured for engaging elastically said annular groove of the pin so as to withhold the pin provisionally within said articulation seat in the direction of the axis of articulation.

As will emerge clearly from the ensuing description, with the hinge according to the present invention it is no longer necessary to keep the hinge-pin and the washer in position, since the washer is configured for withholding the pin provisionally within the articulation seat of the fixed hinge element. In this way, it is possible to position the mobile hinge element in alignment with the fixed hinge element, without simultaneously having to keep the washer and the pin in position. When the mobile hinge element has been positioned in alignment with the fixed hinge element, it is sufficient to push the pin axially to complete the assembly. The solution according to the present invention enables assembly to be made even by just one operator.

The present invention can be applied both to two-leaf hinges formed only by a fixed hinge element and by a mobile hinge element, and to three-leaf hinges, with a mobile hinge element set between two fixed hinge elements.

### DESCRIPTION OF THE DRAWINGS

The present invention will now be described in detail with reference to the attached drawings, which are provided purely by of way of non-limiting example, and in which:

FIG. 1 is an exploded perspective view of a hinge according to the present invention partially mounted on the frame of a door or window;

FIG. 2 is a perspective view from a different angle of the part indicated by the arrow II in FIG. 1;

FIG. 3 is a cross section according to the line III-III of FIG. 2;

FIG. 4 is a perspective view at a larger scale and with a different angle of the washer indicated by the arrow VI in FIG. 2;

FIGS. 5-8 are perspective views that show the sequence of assembly of the hinge according to the present invention;

FIG. 9 is a cross section according to the line IX-IX of FIG. 7;

FIG. 10 is a detail at a larger scale of the part indicated by the arrow X in FIG. 9; and

FIG. 11 is a cross section according to the line XI-XI of FIG. 8.

### DESCRIPTION OF THE PREFERRED EMBODIMENT

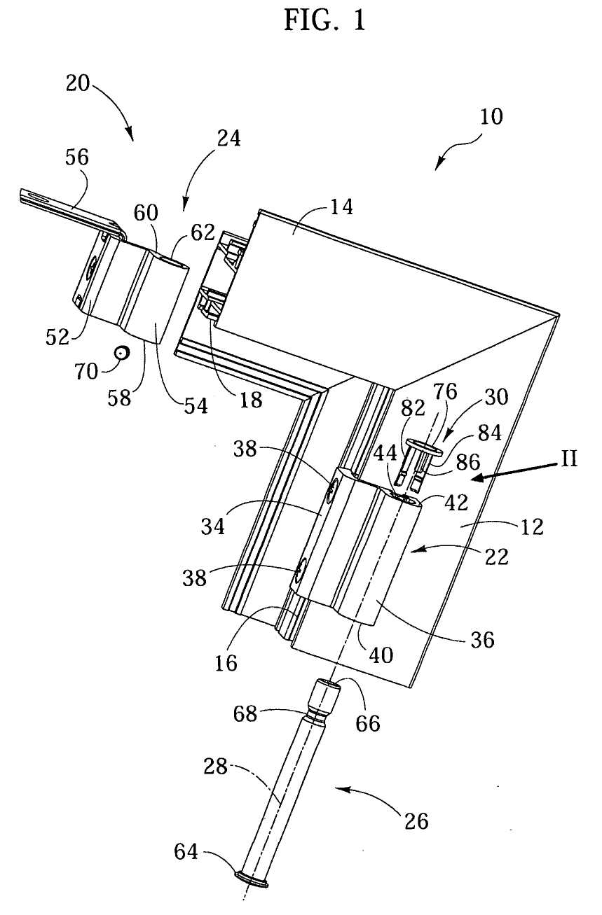

With reference to FIG. 1, designated by 10 is a part of a fixed frame of a door or window, including a vertical upright 12 and a horizontal cross member 14. The uprights and the cross members forming the frame 10 are made up of aluminum sectional elements having, in a known way, longitudinal grooves 16, 18 facing the inside of the door or window.

Designated by 20 in the figures is a hinge according to the present invention. The hinge 20 comprises a first hinge element 22 that is to be fixed to the fixed frame 10, a second hinge element 24 that is to be connected to the openable leaf (not illustrated) of the door or window, and a hinge-pin 26 defining an axis of articulation 28. The hinge 20 according to the present invention moreover comprises a washer 30 that will be described in greater detail in what follows.

With reference to FIGS. 1-3, the first hinge element 22 is formed by a monolithic body of metal material having a fixing portion 34 and an articulation portion 36. The fixing portion 34 is configured for being fixed in the longitudinal groove 16 of the upright 12 by means of a pair of screws 38. The way in which the first hinge element 22 is fixed to the upright 12 is conventional in the sector of accessories for doors and windows made of aluminum and does not call for an in-depth description.

The first hinge element 22 has a bottom front end 40 and a top front end 42. The articulation portion 36 has a through articulation seat 44 that extends between the front ends 40, 42. With reference in particular to FIG. 3, the articulation seat 44 comprises three longitudinal grooves 46 that project outwards with respect to a circular profile. In the example illustrated in the figures, the grooves 46 are not set at equal angular distances apart from one another. The internal surface of the articulation seat 44 has a circular profile between each pair of adjacent grooves 46.

With reference to FIG. 1, the second hinge element 24 comprises a fixing portion 52 and an articulation portion 54. The fixing portion 52 is configured for fixing to an L-shaped arm 56. The arm 56 serves to connect the second hinge element 24 to the openable leaf of the door or window. The L-shaped arm 56 constitutes the terminal end of a scissor-like arm in the case of a door or window with wing-like and swivel-like opening. In the case of a door or window that can only be opened in a wing-like way, the L-shaped arm 56 is fixed to a cross member of the openable leaf.

The articulation portion 54 of the second hinge element 24 has a bottom front end 58 and a top front end 60. The articulation portion 54 has a through articulation seat 62 with circular cross section that extends between the front ends 58, 60.

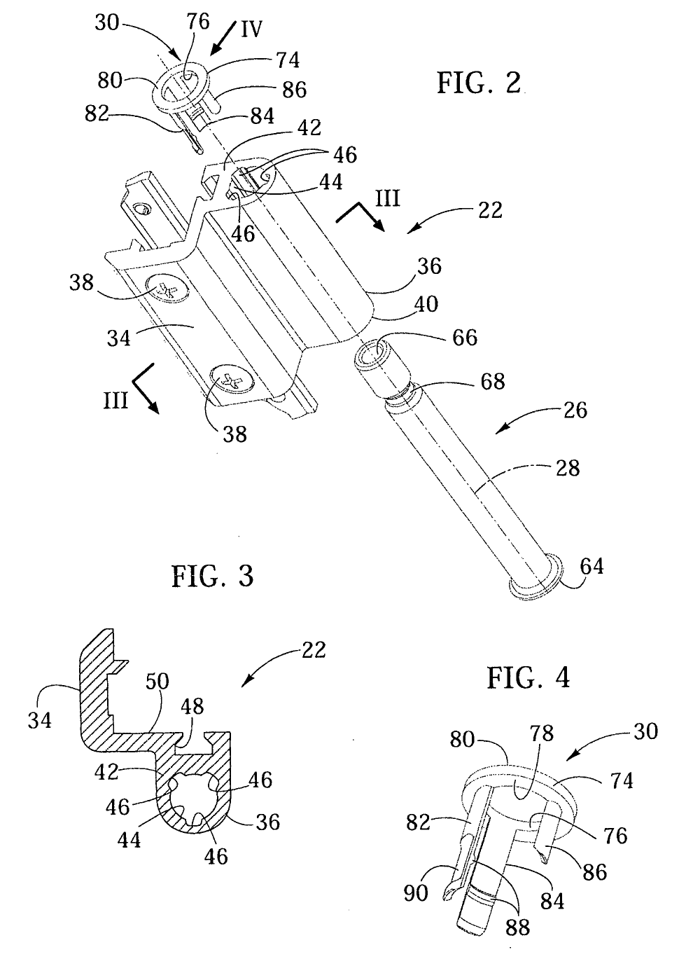

With reference to FIGS. 1 and 2, the hinge-pin 26 has a cylindrical body with circular cross section having at a first end a widened head 64. At the opposite end with respect to the head 64, the pin 26 can be provided with a blind hole 66 coaxial to the axis 28. Said hole serves for the application of an extension element that can be fitted to a third hinge element, as described in detail in a simultaneous patent application filed in the name of the present applicant. The pin 26 is provided on its external surface with an annular groove 68 situated at a distance from the head 64 greater than the length of the articulation portion 36 of the first hinge element 22. Preferably, the pin 26 has an external surface with constant diameter, with the exception of stretches in which the annular groove 68 and the head 64 are formed. The annular groove 68 is to be engaged by a threaded grubscrew 70 that is screwed into a transverse threaded hole 72 (FIG. 11) formed in the articulation portion 54 of the second hinge element 24.

With reference in particular to FIG. 4, the washer 30 comprises an annular disk 74 having a hole 76 with a diameter slightly greater than the external diameter of the pin 26. The annular disk 74 has a bottom plane surface 78 that is to rest against the top front end 42 of the first hinge element 36. The bottom front surface 58 of the second hinge element 24 is to rest on a top plane surface 80 of the annular disk 74.

The washer 30 comprises at least one extension that extends parallel to the axis 28 and within the articulation seat 44 of the first hinge element 22. Said extension has at least one tooth configured for engaging elastically the annular groove 68 of the pin 26 so as to withhold the pin provisionally within the articulation seat 44 in the direction of the axis of rotation 28.

In the embodiment illustrated in the drawings, the washer 30 comprises three arms 82, 84, 86 that extend from the bottom plane surface 78 of the annular disk 74. The arms 82, 84, 86 extend parallel to the axis of the hole 76 and have respective cylindrical internal surfaces with the same radius as the hole 76. Each of the two arms 82, 84 is provided on its internal surface with a tooth 88 and, on the external surface, with a portion of reduced thickness 90. The tooth 88 is situated in a substantially intermediate position of the portion of reduced thickness 90. In the embodiment illustrated in the drawings, the third arm 86 has a length smaller than that of the arms 82, 84 and is without the tooth 88 and the portion of reduced thickness 90. The arms 82, 84, 86 are made integrally with the annular disk 74. The washer 30 is preferably made of injected plastic material having good elastic characteristics so that the portions on which the teeth 88 are formed can undergo elastic deformation in a radial direction. The arms 82, 84, 86 are inserted in the respective grooves 46 of the hinge seat 44 of the first hinge element 22. The arm 86 of smaller length serves to provide a reference for the correct positioning of the washer in view of the fact that the grooves 46 are not set at equal distances apart. Alternatively, the grooves 46 could be set at equal distances apart, and the arm 86 could be identical to the arms 82, 84.

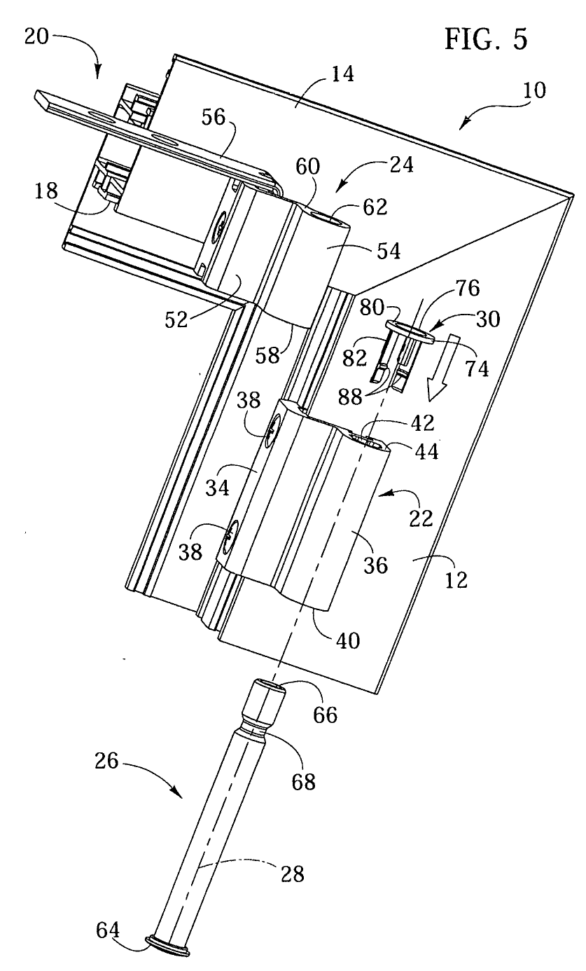

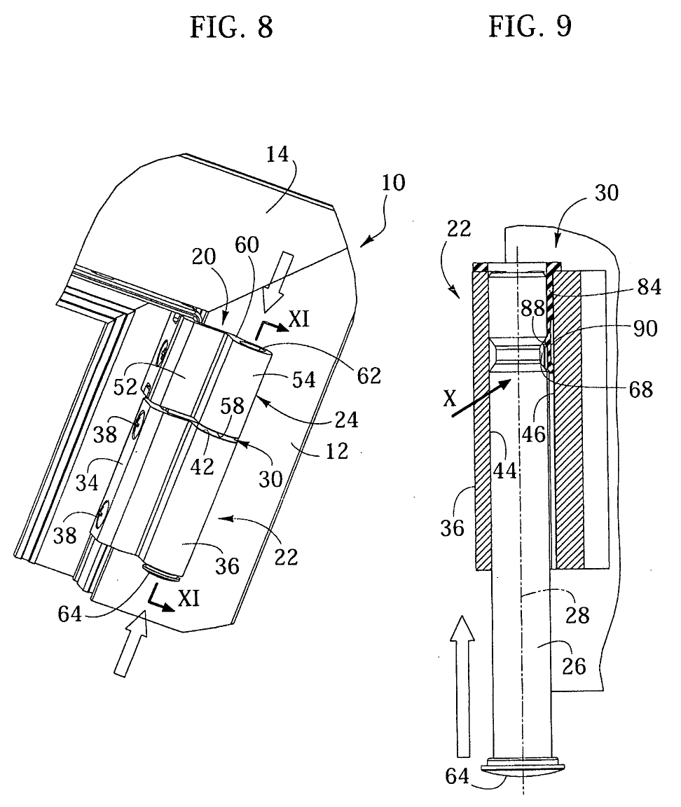

The assembly of the hinge according to the present invention is carried out according to the sequence of operations illustrated in FIGS. 5-8.

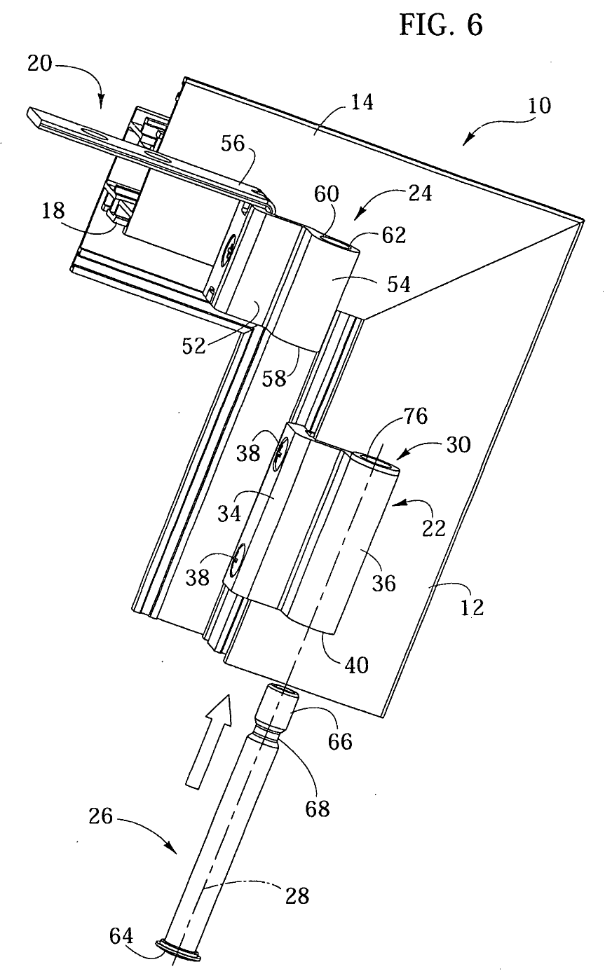

Initially, the first hinge element 22 is fixed to the fixed frame 10 of the door or window, and the second hinge element 24 is fixed to the mobile leaf. Then, the washer 30 is applied to the first hinge element 22 in the direction indicated by the arrow in FIG. 5. The arms 82, 84, 86 are inserted within the longitudinal grooves 46. FIG. 6 shows the hinge after insertion of the arms 82, 84, 86 of the washer 30 in the respective grooves 46. In this configuration, the bottom plane surface 78 of the washer 30 rests on the top front end 42 of the first hinge element 22.

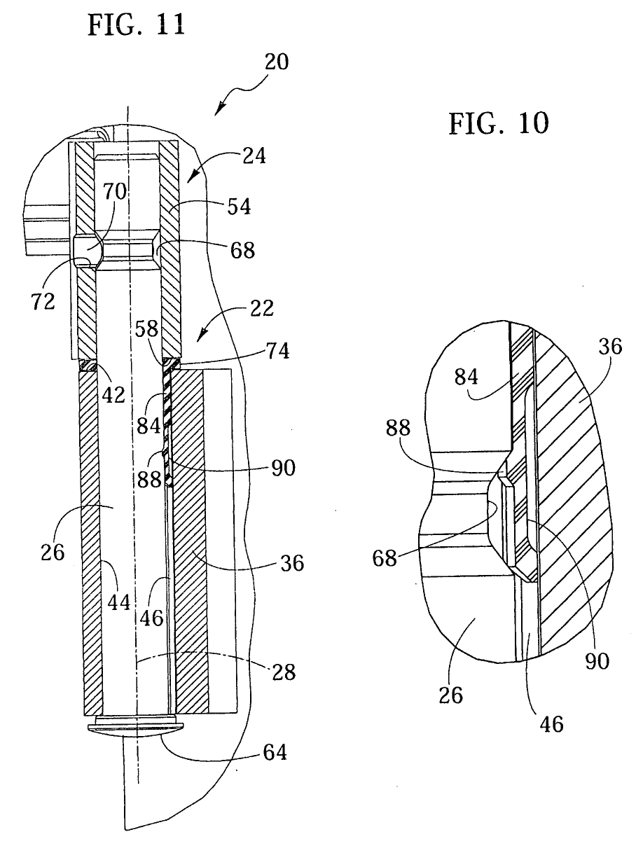

Then, the pin 26 is inserted from beneath into the articulation seat 44, in the direction indicated by the arrow in FIG. 6. The pin 26 is inserted axially until the teeth 88 of the washer 30 snap into engagement with the annular groove 68, as illustrated in FIGS. 9 and 10. As may be noted in these figures, the teeth 88 project in a radial direction towards the inside of the articulation seat 44 and interfere with the external surface of the pin 26. The portions of small thickness 90 of the arms 82, 84 create a free space in a radial direction in a position corresponding to the teeth 88. Consequently, during insertion of the pin 26, the teeth 88 can undergo deformation in a radial direction to enable axial insertion of the pin. The teeth 88 snap into engagement with the annular groove 68 of the pin 26 as soon as this groove is located in a position corresponding to the teeth 88.

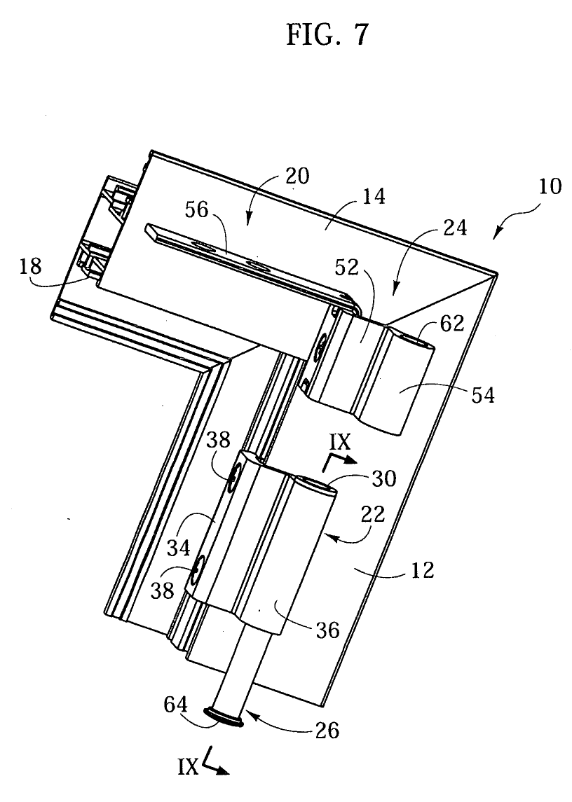

In the configuration illustrated in FIGS. 7 and 9, the pin is withheld within the articulation seat 44 by the washer 30. At the same time, the washer is withheld in the correct position by the arms 82, 84, 86. At this point, the second hinge element 24 is positioned with the articulation seat 62 aligned with respect to the articulation seat 44 of the first hinge element 22. In order to make this positioning it is not necessary to keep the pin 26 and the washer 30 in position. After having correctly aligned the articulation seats 44, 62 of the first hinge element 22 and the second hinge element 24 with respect to one another, the pin 26 is pushed upwards. The annular groove 68 of the pin 26 is released from engagement with the teeth 88, and the top end of the pin 26 fits into the articulation seat 62 of the second hinge element 24. Finally, the threaded grubscrew 70 is screwed in the transverse hole 72 of the second hinge element 24 for fixing the second hinge element 24 to the pin 26, as illustrated in FIG. 11.

From the foregoing description, it is clear that during assembly of the mobile leaf it is not necessary to keep the pin and the washer in position given that they are withheld in the correct position by the first hinge element 22. Consequently, the assembly of the mobile leaf can be performed by just one person.

1. A hinge for doors or windows, comprising a hinge-pin defining an axis of articulation, a first hinge element and a second hinge element articulated to one another about said axis via said pin, in which the first hinge element and the second hinge element have respective articulation seats for coupling with said pin and respective front surfaces facing one another, in which a washer is set between said front facing surfaces, and in which said pin has an annular groove on its external surface for engagement by a fixing screw carried by the second hinge element, said washer comprising at least one extension, which extends within the articulation seat of the first hinge element parallel to said axis of articulation, said extension having at least one tooth configured for engaging elastically said annular groove of the pin so as to withhold the pin provisionally within said articulation seat in the direction of the axis of articulation.

2. The hinge according to claim 1, wherein said washer comprises an annular disk and at least one arm, which extends from a plane surface of said disk, said at least one arm having an internal surface, on which said tooth is formed.

3. The hinge according to claim 2, wherein said washer comprises three arms, which extend axially.

4. The hinge according to claim 3, wherein the articulation seat of the first hinge element has three axial grooves designed to receive said arms of the washer.

5. The hinge according to claim 4, wherein said tooth is situated on a portion of reduced thickness of the respective arm.
